(19) United States
(12) Patent Application Publication
(10) Pub. No.: US 2010/0094994 A1
(43) Pub. Date: Apr. 15, 2010

(54) NETWORK STRUCTURE INFORMATION ACQUIRING METHOD AND DEVICE

(75) Inventor: Mitsuru YOSHIDA, Wako-shi (JP)

Correspondence Address: BRUNDIDGE & STANGER, P.C., 1700 DIAGONAL ROAD, SUITE 330, ALEXANDRIA, VA, 22314, US

(73) Assignee: Riken

(21) Appl. No.: 12/575,702

(22) Filed: Oct. 8, 2009

(30) Foreign Application Priority Data
Oct. 14, 2008 (JP) 2008-265461

(51) Int. Cl. G06F 15/16

(52) U.S. Cl. 709/224

(57) ABSTRACT

A method for acquiring information about connection relationships in a network as a tree structure having a predetermined network device as a root node, includes the steps of acquiring information about the ports held by each of the network devices, and the network devices connected to each of the ports from each of the network devices; and determining connection relationships in the network, based on the fact that an arbitrary partial tree in the tree structure is smaller than an upstream partial tree containing the arbitrary partial tree.

### BACKGROUND OF THE INVENTION

1. Field of the Invention

The present invention relates to a technique for analyzing the connection relationships in an existing network.

2. Description of the Related Art

Computer networks are large in scale in these days, and tens or hundreds of network devices are connected to one computer network. To accurately manage such a computer network, the manager needs to understand the latest network structure.

The most primitive method for managing a network structure is manually creating a network structure diagram and updating the structure diagram every time a change is made to the network structure. By this method, not only the updating of the structure diagram is troublesome, but also the following problems are caused: if the manager fails to update the structure diagram, the latest structure cannot be understood; and a check cannot be made to determine whether the current structure diagram correctly reflects the latest structure.

Therefore, there is a demand for automatic acquirement of network structures. Such techniques for automatically acquiring network structures are disclosed in Japanese Patent Application Laid-Open Nos. 2004-86729 and 2003-124932, for example.

### SUMMARY OF THE INVENTION

However, there is a problem that conventional techniques for acquiring information about connections in networks are not reliable. Therefore, the present invention is to provide a technique for acquiring accurate information about the connections in a network.

The present invention provides a network structure information acquiring method for determining the connection relationships in a network formed with network devices as a tree structure having a predetermined network device as the root node. According to the present invention, the structure of a network is characteristically determined based on the fact that an arbitrary partial tree is smaller than an upstream partial tree containing the arbitrary partial tree in the tree structure.

Network structure information acquiring methods according to the present invention may be roughly divided into methods for successively determining connection relationships starting from the upstream side of the tree structure, and methods for successively determining connection relationships starting from the downstream side.

In this specification, the terms “upstream” and “downstream” are used in the following meanings. With a certain network device being the root node in a tree structure, the side to which the root node is connected is defined as the “upstream” side, and the side to which the root node is not connected (but edge nodes are connected) is defined as the “downstream” side. Also, among the ports held by the network devices, the ports to which the root node is connected are referred to as the “upstream ports”, and the other ports are referred to as the “downstream ports”.

In a first embodiment of the present invention, connection relationships are successively determined, starting from the upstream side of the tree structure. First, the information about the ports held by the network devices and the network devices connected to the ports is acquired from all the network devices. Here, “network devices connected to the ports” include both network devices connected directly to the ports and network devices connected to the ports via other network devices.

The connection relationships are then successively determined, starting from the network device on the upstream side in the following manner. First, the root node is regarded as the network device having a connection relationship determined. Thereafter, among the network devices connected to a downstream port (hereinafter referred to as the subject port) of the network device having a connection relationship already determined, the device having the largest number of devices connected to the downstream port (hereinafter referred to as the downstream devices) is determined to be the network device connected directly to the subject port. This determining procedure is repeatedly carried out. In other words, which network devices are connected directly to the subject ports are successively determined, starting from the upstream side. By repeating this procedure, the connection relationships of all the network devices can be determined.

The subject port may be selected in arbitrary order. Various methods may be employed, such as a depth preferential method or a width preferential method. In a case where a network device having a connection relationship determined has more than one downstream port, it is preferable that a connection relationship determining procedure is carried out on the respective ports in a parallel (simultaneous) manner.

This embodiment is based on the fact that an arbitrary partial tree is smaller than a partial tree containing the arbitrary partial tree in a tree structure, or an arbitrary partial tree is larger than a partial tree contained in the arbitrary partial tree in the tree structure. In this embodiment, according to the principles, among the network devices having connection relationships undetermined, the network device having the largest partial tree with the root being the own device is located at the most upstream side.

By the network structure information acquiring method according to this embodiment, the connection relationships in a network formed with network devices can be accurately determined in the form of a tree structure. By determining the connection relationships starting from the upstream side, processing can be performed on more than one port in a parallel manner. Thus, high-speed operations can be performed.

In a second embodiment of the present invention, connection relationships are successively determined, starting from the upstream side of a tree structure, as in the first embodiment. In this embodiment, after the information about the ports of each network device is acquired as in the first embodiment, connection relationships are successively determined by identifying the device connected directly to the subject upstream port, starting from the device having the largest number of downstream devices. The device having the largest number of downstream devices among the devices having connection relationships undetermined is the device that has an upstream port connected directly to a downstream port of a device having a connection relationship already determined. In this manner, the connection relationships are determined.

This embodiment is based on the fact that the root node has the largest number of downstream devices, which is an applied approach based on the fact that an arbitrary partial tree is smaller than an upstream partial tree containing the arbitrary partial tree. When the network structure (a tree structure) is determined from the upstream side, the determining procedure is carried out based on the fact that the root node of a tree structure (or one of tree structures) formed with devices having connection relationships undetermined is the device having the largest number of downstream devices. By the network structure information acquiring method according to this embodiment, the connection relationships in a network formed with network devices can also be accurately determined in the form of a tree structure.

In a third embodiment of the present invention, connection relationships are successively determined, starting from the downstream side of a tree structure. After the information about the ports of each network device is acquired as in the first and second embodiments, the connection relationships are successively determined in the following manner, starting from a network device on the downstream side. First, network devices having no downstream ports are identified as edge nodes (leaf nodes). After that, among the network devices other than the edge nodes, the connection relationships are determined by successively identifying the device connected directly to a subject downstream port, starting from the network devices having the smallest downstream devices.

Here, the network devices determined to be connected directly to downstream ports of network devices are defined as devices having connection relationships already determined. Through this procedure, among the network devices connected to a downstream port of a network device to be processed, there remains only one network device having a connection relationship undetermined. Accordingly, the network device can be identified as the network device connected directly to the downstream port of the switch to be processed.

Alternatively, among the network devices connected to a downstream port of a network device to be processed, the network device having the largest number of downstream devices may be determined to be the network device connected directly to the downstream port.

According to this embodiment, based on the fact that an arbitrary partial tree is smaller than the upstream partial tree containing the arbitrary partial tree, the connection relationships in a network formed with network devices can also be accurately determined in the form of a tree structure.

In a fourth embodiment of the present invention, connection relationships are successively determined from the downstream side of a tree structure, as in the third embodiment. After the information about each port of the network devices is acquired as in the first through third embodiment, the connection relationships are successively determined in the following manner, starting from a network device on the downstream side. First, connection relationships are determined, with the edge nodes (leaf nodes) being the network devices having no downstream ports. After that, among the network devices having connection relationships undetermined, a network device with downstream devices all having connection relationships determined is detected, and the connection relationship of the detected network device is determined. This procedure is repeated, so as to determine the connection relationships of all the network devices.

This embodiment is based on the fact that the node closer to the edge has the smaller number of downstream devices, which is an applied approach based on the fact that an arbitrary partial tree is smaller than an upstream partial tree containing the arbitrary partial tree. By the network structure information acquiring method according to this embodiment, the connection relationships in a network formed with network devices can also be accurately determined in the form of a tree structure.

The present invention may be regarded as a network structure information acquiring method that includes at least part of the above described procedures. The present invention may also be regarded as a network structure information acquiring device that carries out at least part of the above described procedures, or a program for implementing the network structure information acquiring method. The components and procedures described above may be combined in all possible manners, so as to embody the present invention.

According to the present invention, network connection information can be accurately acquired.

### BRIEF DESCRIPTION OF THE DRAWINGS

FIG. 1 illustrates a network formed with L2 switches in the form of a tree structure;

FIG. 2 is a functional block diagram of a management terminal;

FIG. 3 is a flowchart showing an entire network structure information acquiring operation;

FIG. 4 shows the structure of a port information table, and the data corresponding to the network structure illustrated in FIG. 1;

FIG. 5 is a flowchart showing a specific network structure analyzing operation according to a first embodiment;

FIG. 6 is a flowchart showing a specific network structure analyzing operation according to a second embodiment;

FIG. 7 is a flowchart showing a specific network structure analyzing operation according to a third embodiment;

FIG. 8 is a flowchart showing a specific network structure analyzing operation according to a fourth embodiment; and

FIG. 9A illustrates a network including an uncontrolled switch, and FIG. 9B shows the results of an analysis of the network structure.

### DESCRIPTION OF THE EMBODIMENTS

The following is a detailed description of preferred embodiments of the present invention through examples, with reference to the accompanying drawings.

### First Embodiment

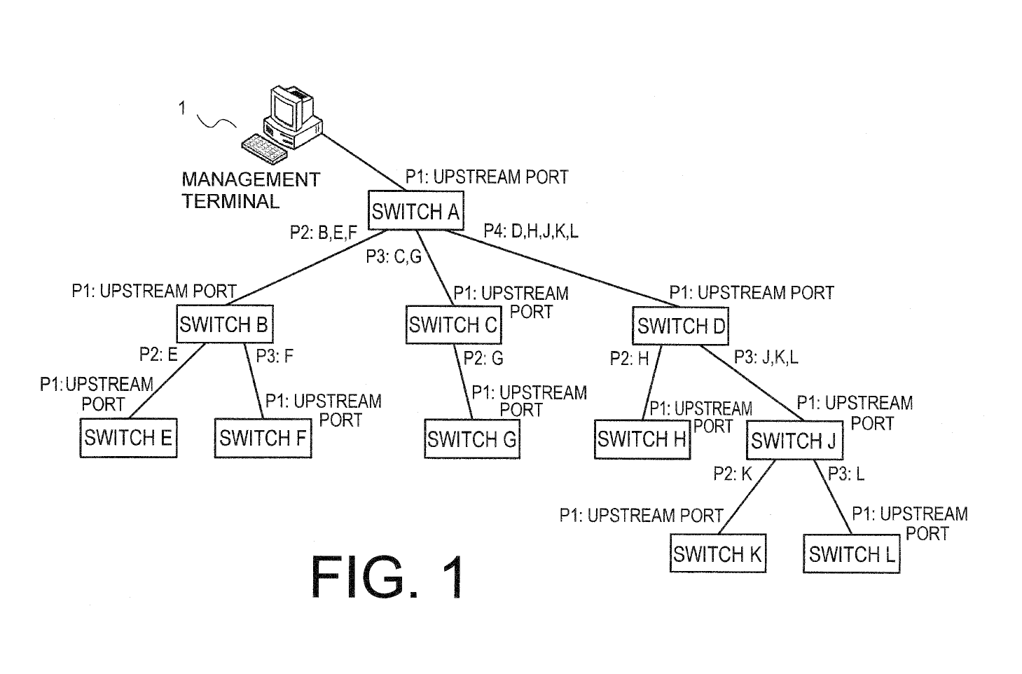

In this embodiment, a method for acquiring the information of the physical connection relationships in a network formed with L2 switches (a network structure information acquiring method), and the structure of a management terminal that performs the acquiring operation (a network structure information acquiring device) are described. Not including a loop, the network formed with the L2 switches is represented by a tree structure that has an arbitrary switch as a root node, as shown in FIG. 1. Although a switch A to which a management terminal 1 is connected directly is used as the root node, any other switch may be used as the root node.

Here, the management terminal 1 functions as a SNMP manager, and each switch functions as a SNMP agent. To disclose the combination of a MAC (Media Access Control) address and a port, each switch has dot1dTpFdbPort of BRIDGE-MIB (RFC1493) mounted thereon.

### (Entire Structure)

The management terminal 1 acquires the information about the port connection from each switch, and analyzes the information. By doing so, the management terminal 1 acquires the network structure (physical connections) as the tree structure shown in FIG. 1.

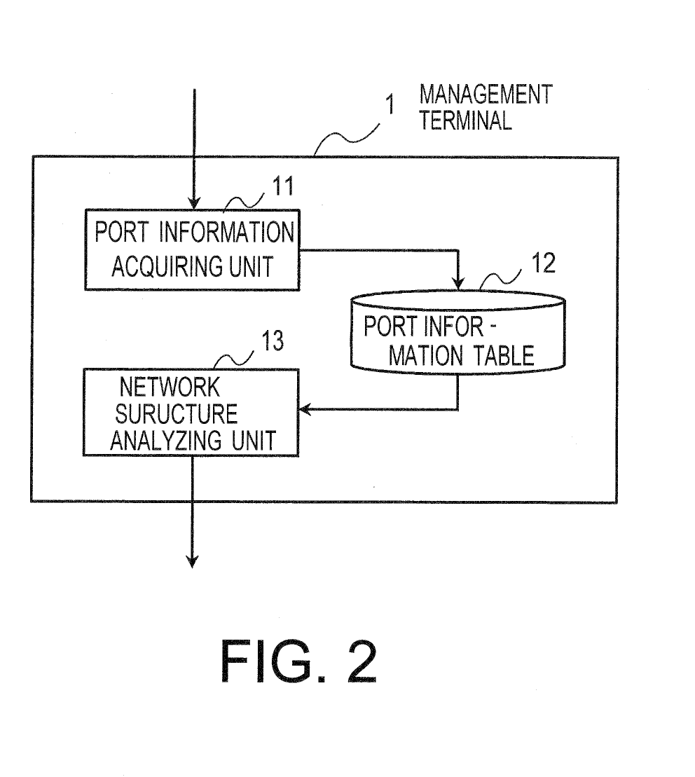

FIG. 2 is a block diagram showing the functional structure of the management terminal 1. As shown in FIG. 2, the management terminal 1 includes a port information acquiring unit 11, a port information table 12, and a network structure analyzing unit 13. These functional units are realized by the CPU loading various programs from an auxiliary storage device into a main storage device and executing the programs. However, some or all of the functional units may be realized by special-purpose hardware.

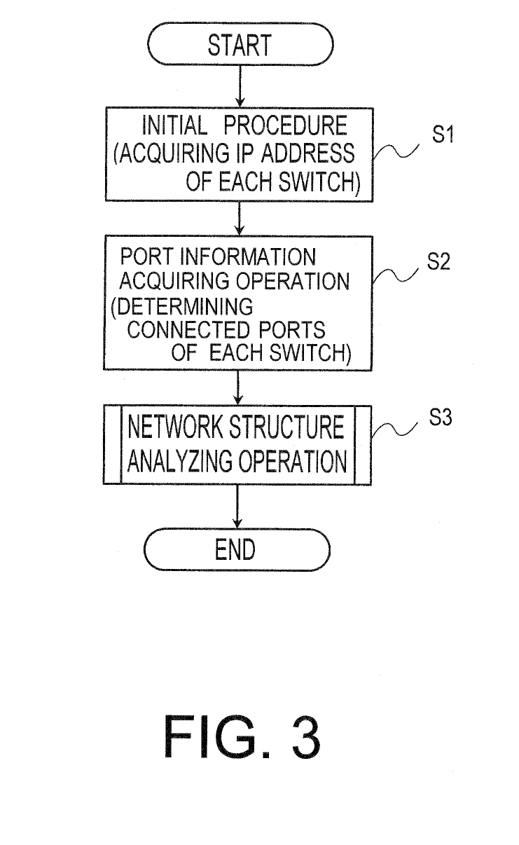

Referring now to the flowchart of FIG. 3, the operations of the respective functional units are described. FIG. 3 is a flowchart showing the entire network structure information acquiring operation. First, in the initial procedure (S1), the port information acquiring unit 11 acquires the IP address of each switch. The IP address of each switch may be acquired by various techniques. For example, the IP address of each switch may be input as configuration information from outside. Alternatively, an address that responses to a “Ping” transmitted to the addresses within a designated IP address range may be acquired as the IP address of a switch.

Also, in the initial procedure, the management terminal performs communications with the respective switches, so as to register the information about the other switches in the forwarding database (FDB) of each switch. However, there is no need to perform further communications, if device detection is carried out with the use of a “Ping”. Accordingly, each switch relays a communication destined for a switch located on a downstream side of the subject node. Therefore, the information about all the switches on the downstream side is registered in the forwarding database. Meanwhile, only the information about the management terminal is registered in the forwarding database in the upstream device.

The port information acquiring unit 11 then acquires the port information about each switch, and stores the port information into the port information table 12 (S2). Here, the port information about a switch is the information indicating to which port the switch (or the MAC address of the switch) is connected. This information can be acquired from the forwarding database (FDB) of each switch. More specifically, the information indicating to which ports the MAC addresses of the other switches are connected can be acquired for each switch with the use of dot1dTpFdbPort of BRIDGE-MIB. The MAC address of each switch can be acquired from an ARP (Address Resolution Protocol) table.

The port information acquiring unit 11 also determines to which port of each switch the management terminal 1 is connected in the same manner as above. In this embodiment, the switch to which the management terminal 1 is connected directly is defined as the root node. Accordingly, a check can be made to determine whether a port is an upstream port or a downstream port, depending on whether the management terminal 1 is connected to the port.

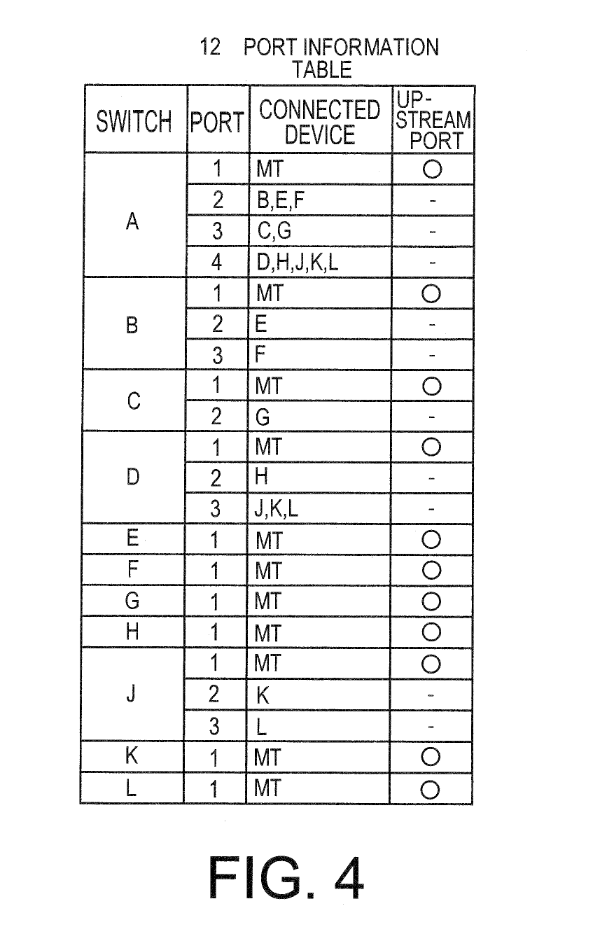

FIG. 4 shows an example of the port information table 12 created in the above manner. The contents of the data shown in FIG. 4 correspond to the network structure shown in FIG. 1. The port information table 12 stores the information indicating which switch is connected to the port of each of switches A through L. In FIG. 4, “MT” represents the management terminal 1. Accordingly, the ports to which the management terminal 1 (MT) is connected are recognized as the upstream ports.

As described above, the information indicating which switch is connected to the port of each switch is stored in the port information table 12. All the information about the downstream ports is reflected correctly, but the information about the upstream ports is not necessarily reflected correctly. FIG. 4 shows a situation where only the information about the management terminal 1 is registered with the upstream ports.

The information about the upstream ports is not completely reflected in the port information table 12, because the information about the switches on the downstream side of the subject switch is thoroughly registered, but the information about the switches on the upstream side of the subject switch is not necessarily registered thoroughly in the forwarding database (FDB) of each switch. For example, to have the information about the switch B registered in the forwarding database of the switch A, the switch A needs to relay communications originated from the switch B or destined for the switch B. If the switch B is located on the downstream side of the switch A, communications between the management terminal 1 and the switch B pass through the switch A, and accordingly, the information about the switch B is registered in the forwarding database of the switch A. Since the management terminal 1 communicates with all the switches so as to detect devices in the network in the initial procedure, each switch relays communications destined for all the switches located on the downstream side of the subject switch. Through the communications, the information about all the switches on the downstream side is registered in each switch. On the other hand, even if the management terminal 1 communicates with the respective switches, each of the switches does not relay communications originated from or destined for the switches located on the upstream side of the subject switch. Therefore, the forwarding database about the upstream ports is not necessarily complete.

In a case where a downstream switch relays communications destined for or originated from upstream switches, the information about the upstream ports can be acquired. For example, when the port information table 12 is created, the edge node (the most downstream switch) is controlled to communicate with all the switches located on the upstream side of the switch. In this manner, the port information table 12 having the information about the upstream ports thoroughly registered therein can be created. In the following description, however, the information about the upstream ports in the port information table 12 is assumed to be incomplete.

### (Network Structure Analyzing Operation)

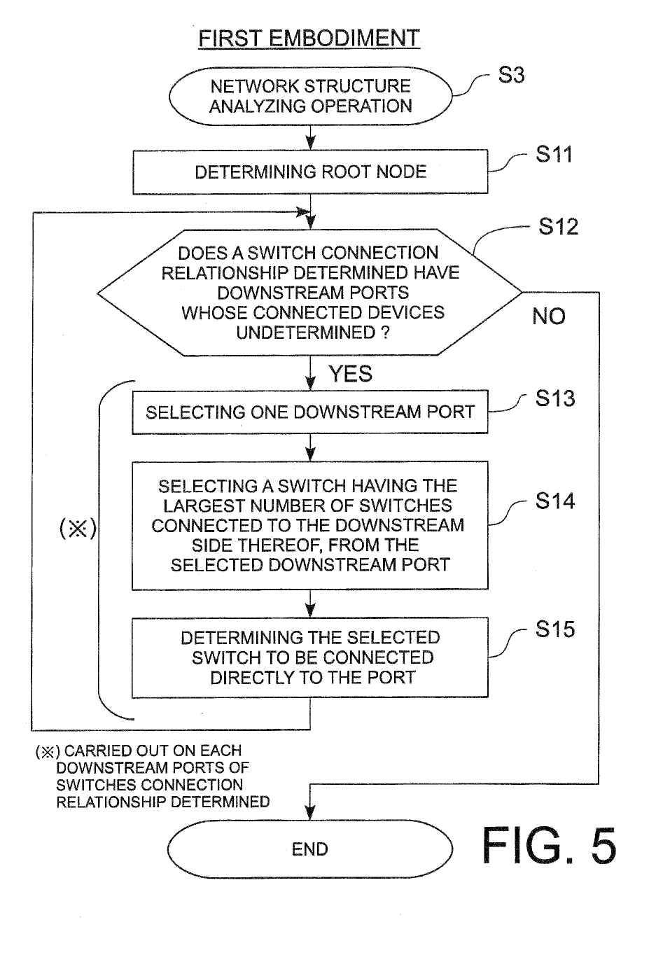

After the port information table 12 is created, the network structure analyzing unit 13 analyzes the port information table 12, and acquires network structure information (S3). Referring now to the flowchart of FIG. 5, the contents of the network structure analyzing operation are described more in detail.

First, based on the port information table 12, the switch that is the root node is determined (S11). The root node can be defined as the switch having the largest number of devices connected to its downstream port among all the switches. In this embodiment, the connection relationship of the root node is first determined among all the switches.

A check is made to determine whether the switch having its connection relationship already determined has downstream ports yet to have devices determined to be connected thereto (S12). If there are downstream ports yet to have devices determined to be connected thereto (S12—YES), the switch connected directly to each of the downstream ports is determined in the following manner.

First, one port is selected from the downstream ports yet to have devices determined to be connected thereto (S13). In the following, this port will be referred to as the object port. If there are two or more downstream ports yet to have devices determined to be connected thereto, any one of the downstream ports may be arbitrarily selected. Next, the switch having the largest number of switches connected to its downstream ports is selected from the switches connected to the downstream side of the object port (S14). The switch selected in this way is determined to be the switch connected directly to the object port (S15). This determination is made for the following reasons. First, the switches connected to the downstream side of the object port are expressed as a partial tree in which the root node is the switch connected directly to the object port. The partial tree is larger than partial trees contained therein. Accordingly, the switch that has the largest number of switches connected to its downstream side can be determined to be the root node of the partial tree or the switch connected directly to the object port.

The above procedures of steps S13 through S15 are repeated until all the ports have devices determined to be connected thereto. When the last undetermined downstream port has a device determined to be connected thereto (S12—NO), the operation comes to an end, and the network structure information is acquired as a tree structure.

### (Exemplary Operation)

A specific example of the network structure analyzing operation to be performed according to this embodiment in the network illustrated in FIG. 1 is described. Since the port information table 12 corresponding to the network illustrated in FIG. 1 is shown in FIG. 4, the specific example of the network structure analyzing operation is described also with reference to FIG. 4.

First, based on the port information table 12, the switch A having the largest number of devices connected to its downstream ports is determined to be the root node (S11). In this example, the depth of the tree structure is preferentially determined in the determination of the physical connection relationship.

The switches B, E, and F are connected to the port P2 of the switch A, and the numbers of downstream devices of those switches are 2, 0, and 0, respectively. Accordingly, the switch connected directly to the port P2 of the switch A is determined to be the switch B having the largest number of downstream devices.

The switch B has the two downstream ports of ports P2 and P3. Since only the switch E is connected to the port P2 of the switch B, it is apparent that the switch E is connected directly to the port P2 of the switch B.

The switch E does not have a downstream port. Since only the switch F is connected to the port P3 of the switch B, it is apparent that the switch F is connected directly to the port P3 of the switch B. The switch F does not have a downstream port.

The switches C and G are connected to the port P3 of the switch A, and the numbers of downstream devices of those switches are 1 and 0, respectively. Accordingly, the switch connected directly to the port P3 of the switch A is determined to be the switch C having the largest number of downstream devices. Since only the switch G is connected to the port P2 of the switch C, it is apparent that the switch G is connected directly to the port P2 of the switch C. The switch G does not have a downstream port.

The switches D, H, J, K, and L are connected to the port P4 of the switch A, and the numbers of downstream devices of those switches are 4, 0, 2, 0, and 0, respectively. Accordingly, the switch connected directly to the port P4 of the switch A is determined to be the switch D having the largest number of downstream devices.

The switch D has the two downstream ports of ports P2 and P3. Since only the switch H is connected to the port P2 of the switch D, it is apparent that the switch H is connected directly to the port P2 of the switch D. The switches J, K, and L are connected to the port P3 of the switch D, and the numbers of downstream devices of those switches are 2, 0, and 0, respectively. Accordingly, the switch connected directly to the port P3 of the switch D is determined to be the switch J having the largest number of downstream devices.

The switch J has the two downstream ports of ports P2 and P3. Since only the switch K is connected to the port P2 of the switch J, it is apparent that the switch K is connected directly to the port P2 of the switch J. The switch K does not have a downstream port. Since only the switch L is connected to the port P3 of the switch J, it is apparent that the switch L is connected directly to the port P3 of the switch J. The switch L does not have a downstream port.

In the above manner, all the switches connected directly to the ports are determined, and the operation to acquire the information about the physical connections in the network as a tree structure is completed.

### (Modification)

Although the device connected directly to each port is determined in order of depth in the above example, connected devices may be determined in any order. For example, connected devices may be determined in order of width (more specifically, B→C→D→ . . . ).

In a case where one switch has more than one downstream port, a network structure can be determined for each of the ports independently of one another. For example, the switch A has the downstream ports P2, P3, and P4, and the physical connections beyond that can be determined as the respective partial trees existing beyond the ports independently of one another. Accordingly, a parallelizing operation can be performed on each port.

### Second Embodiment

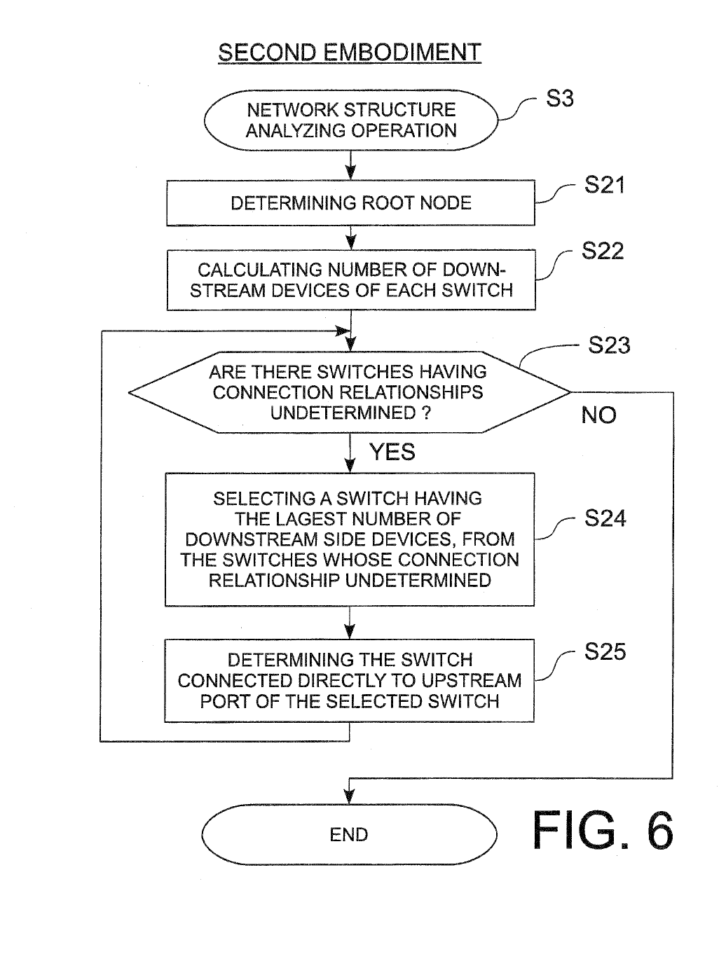

In this embodiment, the information about the physical connection relationships in the network are acquired starting from the upstream side, as in the first embodiment. The fundamental structure according to this embodiment is the same as that of the first embodiment, but the contents of the network structure analyzing operation at step S3 in the flowchart of FIG. 3 differ from those of the first embodiment. FIG. 6 is a flowchart showing the network structure analyzing operation at step S3 according to this embodiment in detail. Referring to FIG. 6, the network structure analyzing operation according to this embodiment is described below.

First, based on the port information table 12, the switch that is the root node is determined (S21). The root node can be defined as the switch having the largest number of devices connected to its downstream port among all the switches. In this embodiment, the connection relationship of the root node is first determined among all the switches.

The number of devices connected to the downstream port of each switch (or the total number of devices connected to the downstream ports of each switch) is determined (S22). A check is made to determine whether there are switches having connection relationships undetermined (S23). The following procedures are repeated while there are undetermined switches.

First, the switch having the largest number of downstream devices is selected from the switches having connection relationships undetermined (S24). The connection relationship of the selected switch is determined (S25). The determination of the connection relationship is carried out by determining the switch connected directly to the upstream port of the selected switch. The switch is determined as the switch having the port having the selected switch connected thereto among the switches having connection relationships determined. If there is more than one switch having such a port, the switch having the smallest number of devices connected to the port is determined as the switch connected directly to the upstream port of the selected switch. Since the partial tree is smaller than the partial tree containing the partial tree, the above determining procedures can be carried out.

The network structure information can be acquired as tree structure information by repeating the above procedures until the connection relationships of all the switches are determined.

### (Exemplary Operation)

A specific example of the network structure analyzing operation to be performed according to this embodiment in the network illustrated in FIG. 1 is described. Since the port information table 12 corresponding to the network illustrated in FIG. 1 is shown in FIG. 4, the specific example of the network structure analyzing operation is described also with reference to FIG. 4.

First, based on the port information table 12, the switch A having the largest number of devices connected to its downstream ports is determined to be the root node (S21). The number of devices connected to the downstream port of each of the switches is determined (S22). The number of downstream devices of the switch D is four, the number of downstream devices of each of the switches B and J is two, the number of downstream devices of the switch C is one, and the number of downstream devices of each of the switches E, F, G, H, K, and L is zero, in descending order.

Among those switches, the connection relationship of the switch D having the largest number of downstream devices is determined. According to the port information table 12, it is apparent that only the switch A has its connection relationship determined, and the switch D is connected to the port P4 of the switch A. Accordingly, the switch connected directly to an upstream port of the switch D is determined to be the switch A (the port P4).

The connection relationships of the switches B and J each having the second largest number of downstream devices are then determined. This procedure may be first carried out on either of the two switches B and J. In this example, the procedure is first carried out on the switch B. According to the port information table 12, it is apparent that, between the switches A and ID having the connection relationships determined, only the port P2 of the switch A has the switch B on its downstream side. Accordingly, the switch connected directly to an upstream port of the switch B is determined to be the switch A (the port P2). According to the port information table 12, it is apparent that, among the switches A, B, and D having the connection relationships determined, the ports having the switch J on their downstream side are the port P4 of the switch A and the port P3 of the switch D. While the number of devices connected to the port P4 of the switch A is three, the number of devices connected to the port P3 of the switch D is two. Accordingly, the switch D is determined to be located on the downstream side of the switch A, and the switch connected directly to an upstream port of the switch J is determined to be the switch D (the port P3).

The connection relationship of the switch C having the third largest number of downstream devices is then determined. Among the switches A, B, D, and J having the connection relationships determined, only the port P3 of the switch A has the switch C on its downstream side. Accordingly, the switch connected directly to an upstream port of the switch C is determined to be the switch A (the port P3).

The connection relationships of the switches E, F, G, H, K, and L each having the fourth largest number of downstream devices are next determined. This procedure may be carried out on those switches in any order. In this example, the processing order is E→F→G→H→K→L. Among the switches having the connection relationships determined, the port P2 of the switch A and the port P2 of the switch B have the switch E connected to their downstream sides. Since the port having the smaller number of devices connected thereto between the two ports is the port P2 of the switch B, the switch connected directly to an upstream port of the switch E is determined to be the switch B (port P2). The same procedure as above is carried out on the other remaining switches, so that the switches connected directly to upstream ports of the switches F, G, H, K, and L are determined to be the switch B (the port P3), the switch C (the port P2), the switch D (the port P2), the switch J (the port P2), and the switch J (the port P3), respectively.

In the above manner, the connection relationships of all the switches are determined, and the operation to acquire the information about the physical connections in the network as a tree structure is completed.

### Third Embodiment

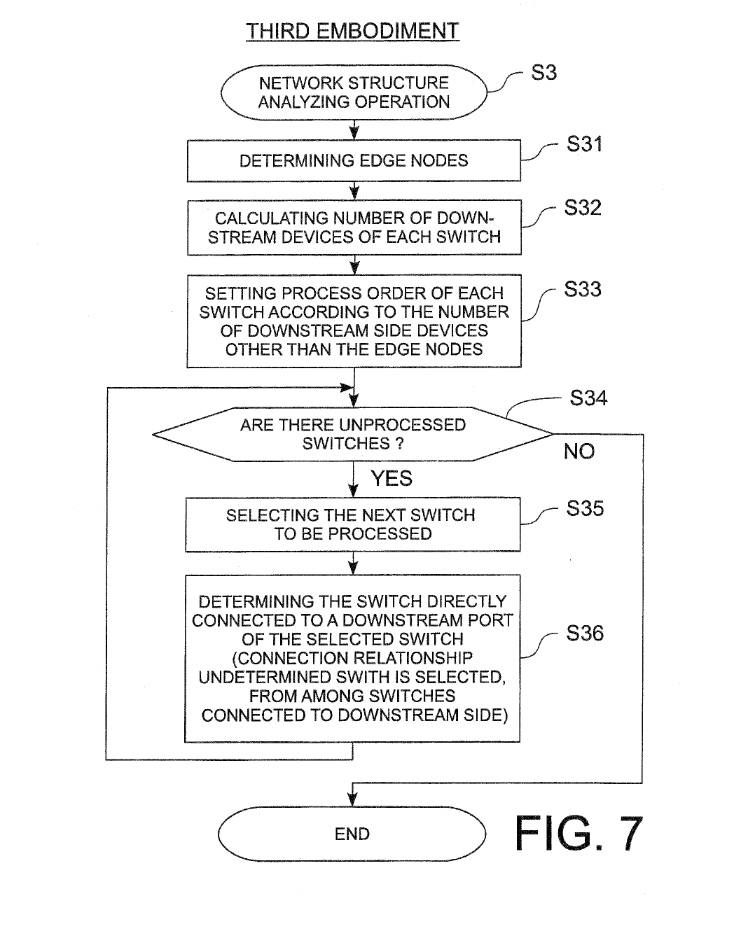

In this embodiment, the information about the physical connection relationships in a network are successively acquired starting from the downstream side, which is the opposite of the operations according to the first and second embodiments. The fundamental structure according to this embodiment is the same as that of the first and second embodiments, but the contents of the network structure analyzing operation at step S3 in the flowchart of FIG. 3 differ from those of the first and second embodiments. FIG. 7 is a flowchart showing the network structure analyzing operation at step S3 according to this embodiment in detail. Referring to FIG. 7, the network structure analyzing operation according to this embodiment is described below.

First, based on the port information table 12, the switches that are the edge nodes are determined (S31). The edge nodes can be defined as the switches having no downstream ports. The number of devices connected to the downstream ports is determined for each of the switches (other than the edge nodes) (S32). The ascending order of the number of downstream devices is set as the processing order for the respective switches other than the edge node switches (S33). If two or more switches have the same number of downstream switches, the processing may be performed on those switches in arbitrary order.

While there are unprocessed switches (S34—YES), the connection relationships are determined in the processing order set at step S33. First, the switch to be processed next (the object switch) according to the processing order is selected (S35), and the switch connected directly to a downstream port of the switch is determined (S36). Among the switches connected to the downstream side of the object switch, the switch connected directly to a downstream port of the selected switch can be determined to be a switch having a connection relationship undetermined (or a switch not added to the later described connected switch list). Since only the edge node exists at a downstream port of the switch having the smallest number of downstream devices, the edge node is determined to be the switch connected directly to a downstream port of the switch having the smallest number of downstream devices. The switch determined to be connected directly to a downstream port of the object switch is then added to the connected switch list. When the switch connected directly to a downstream port of the next object switch is determined (S36), there is only one switch not added to the connected switch list among the downstream devices, and the one switch can be determined to be the switch connected directly to a downstream port.

The above operation is performed on all the switches in the order set at step S33, so that the information about the physical connections in the network is acquired as a tree structure.

### (Exemplary Operation)

A specific example of the network structure analyzing operation to be performed according to this embodiment in the network illustrated in FIG. 1 is described. Since the port information table 12 corresponding to the network illustrated in FIG. 1 is shown in FIG. 4, the specific example of the network structure analyzing operation is described also with reference to FIG. 4.

First, based on the port information table 12, each switch having no downstream ports is determined to be an edge node (S31). In this example, the six switches E, F, G, H, K, and L are edge nodes.

The number of downstream devices of each of the switches (other than the edge nodes) is then determined (S32). The number of downstream devices of the switch C is one, the number of downstream devices of each of the switches B and J is two, the number of downstream devices of the switch D is four, and the number of downstream devices of the switch A is ten, in ascending order. The ascending order of the number of downstream devices is set as the order of the switches to be processed (S33). Accordingly, the processing order is set as C→B→J→D→A.

First, the switch C is selected as the switch to be processed. According to the port information table 12, it is apparent that only the switch G as an edge node is connected to the downstream port P2 of the switch C. Accordingly, the switch connected directly to the downstream port P2 of the switch C is determined to be the switch G. Since the connection relationship of the switch G is determined here, the switch G is added to the connected switch list.

The switch B is next selected as the switch to be processed. According to the port information table 12, it is apparent that the switches E and F as edge nodes are connected to the downstream ports P2 and P3 of the switch B (although the switches added to the connected switch list are excluded here, the switches E and F have not been added to the connected switch list at this point, and therefore, are subjected to the processing). Accordingly, the switches connected directly to the downstream ports P2 and P3 of the switch B are determined to be the switches E and F, respectively. Since the connection relationships of the switches E and F are determined here, the switches E and F are added to the connected switch list. At this point, the connected switch list includes the switches E, F, and G.

The switch J is next selected as the switch to be processed. According to the port information table 12, it is apparent that the switches K and L as edge nodes are connected to the downstream ports P2 and P3 of the switch J (although the switches added to the connected switch list are excluded here, the switches K and L have not been added to the connected switch list at this point, and therefore, are subjected to the processing). Accordingly, the switches connected directly to the downstream ports P2 and P3 of the switch J are determined to be the switches K and L, respectively. Since the connection relationships of the switches K and L are determined here, the switches K and L are added to the connected switch list. At this point, the connected switch list includes the switches E, F, G, K, and L.

The switch D is next selected as the switch to be processed. According to the port information table 12, it is apparent that the switch H as an edge node is connected to the downstream port P2 of the switch D, and the switches J, K, and L are connected to the downstream port P3 of the switch D. Since the switches having connection relationships determined (the switches added to the connected switch list) are excluded (ignored) here, the switches connected directly to the downstream ports P2 and P3 of the switch D are determined to be the switches H and J, respectively. Since the connection relationships of the switches H and J are determined here, the switches H and J are added to the connected switch list. At this point, the connected switch list includes the switches E, F, G, H, J, K, and L.

Lastly, the switch A is selected as the switch to be processed. According to the port information table 12, it is apparent that the switches B, E, and F are connected to the downstream port P2 of the switch A, the switches C and G are connected to the downstream port P3 of the switch A, and the switches D, H, J, K, and L are connected to the downstream port P4 of the switch A. Since the switches having connection relationships determined (the switches added to the connected switch list) are excluded (ignored) here, the switches connected directly to the downstream ports P2, P3, and P4 of the switch A are determined to be the switches B, C, and D, respectively.

In the above manner, the connection relationships of all the switches are determined, and the operation to acquire the information about the physical connections in the network as a tree structure is completed.

### Fourth Embodiment

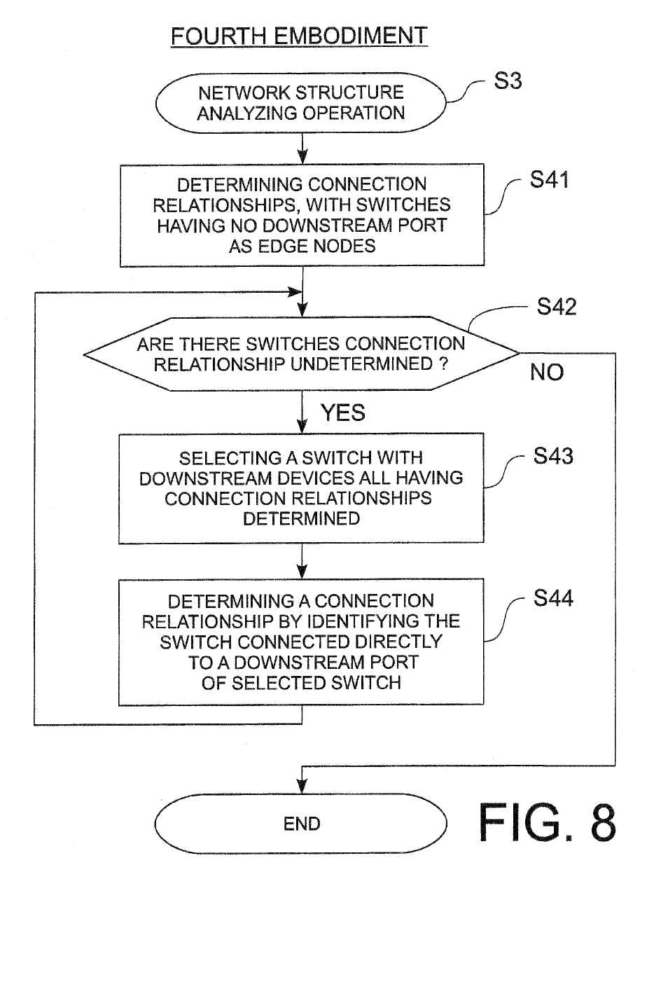

In this embodiment, the information about the physical connection relationships in a network are successively acquired starting from the downstream side, which is the same as in the third embodiment. The fundamental structure according to this embodiment is the same as that of the first through third embodiments, but the contents of the network structure analyzing operation at step S3 in the flowchart of FIG. 3 differ from those of the first through third embodiments. FIG. 8 is a flowchart showing the network structure analyzing operation at step S3 according to this embodiment in detail. Referring to FIG. 8, the network structure analyzing operation according to this embodiment is described below.

First, based on the port information table 12, connection relationships are determined, with edge nodes being the switches having no downstream ports (S41). While there are switches having connection relationships undetermined (S42—YES), the following procedures are repeated.

First, based on the port information table 12, the switch having downstream devices that are switches having connection relationships already determined is selected (S43). A connection relationship is then determined by identifying the switch connected directly to a downstream port of the selected switch (S44). If there is more than one switch having downstream devices that are switches having connection relationships already determined, this procedure is carried out for all those switches. The switch connected directly to a downstream port of the selected switch can be defined as the switch having the largest number of downstream devices among the downstream devices of the selected switch. Alternatively, the switch having a connection relationship determined in the latest loop in the operation loop of steps S42 through S44 may be determined to be the switch connected directly to a downstream port of the selected switch.

The above procedures are repeated until the connection relationships of all the switches are determined, so that the information about the network structure of all the switches can be acquired as a tree structure.

### (Exemplary Operation)

A specific example of the network structure analyzing operation to be performed according to this embodiment in the network illustrated in FIG. 1 is described. Since the port information table 12 corresponding to the network illustrated in FIG. 1 is shown in FIG. 4, the specific example of the network structure analyzing operation is described also with reference to FIG. 4.

First, based on the port information table 12, the connection relationship is determined with edge nodes being switches having no downstream ports (S41). In this example, the six switches E, F, G, H, K, and L are edge nodes.

Among the switches having connection relationships undetermined (the switches other than the edge nodes), switches that have switches connected to downstream ports and all having connection relationships already determined are detected (S43). At this point, such switches are the switches B, C, and J. The switches connected directly to downstream ports of those switches are then identified. Since only the switches E and F are connected to the downstream ports P2 and P3 of the switch B, it is apparent that the switch E is connected to the downstream port P2 of the switch B, and the switch F is connected to the downstream port P3 of the switch B, according to the port information table 12. Likewise, it is apparent that the switch G is connected to the downstream port P2 of the switch C, and the switches K and L are connected to the downstream ports P2 and P3 of the switch J, respectively. In this manner, the connection relationships of the switches B, C, and J are newly determined.

Since the connection relationships of all the switches have not been determined yet at this point, the operation loop of steps S42 through S44 is repeated. The switches having connection relationships undetermined at this point are the switches A and D. Between these two switches, the switch that has switches connected to downstream ports and all having connection relationships already determined is the switch D. The switches connected directly to the downstream ports of the switch D are then identified. Since only the switch H is connected to the downstream port P2 of the switch D, the switch connected directly to the downstream port P2 can be determined to be the switch H. The three switches J, K, and L are connected to the downstream port P3. In this case, the switch J having a connection relationship determined in the latest operation loop is determined to be the switch connected directly to the downstream port P3. Alternatively, the number of downstream devices of each of the switches J, K, and L may be determined, and the switch having the largest number of downstream devices may be determined to be the switch connected directly to the downstream port P3. In this manner, the connection relationship of the switch D is newly determined.

Since the connection relationships of all the switches have not been determined yet at this point, the operation loop of steps S42 through S44 is repeated. The switch having a connection relationship undetermined at this point is the switch A. Since the devices connected to the downstream ports of the switch A all have connection relationships already determined, the switches connected directly to the downstream ports of the switch A are then identified. Although the switches B, E, and F are connected to the downstream port P2 of the switch A, the switch B having a connection relationship determined in the latest operation loop among those three switches is determined to be the switch connected directly to the downstream port P2. Likewise, between the switches C and D connected to the downstream port P3 of the switch A, the switch C is determined to be the switch connected directly to the downstream port P3. Among the switches D, H, J, K, and L connected to the downstream port P4 of the switch A, the switch D is determined to be the switch connected directly to the downstream port P4.

In the above manner, the connection relationships of all the switches are determined, and the operation to acquire the information about the physical connections in the network as a tree structure is completed.

### Other Embodiments

In the above embodiments, the dot1dTpFdbPort of BRIDGE-MIB (RFC1493) is used when the management terminal 1 acquires the information about the ports of each switch. However, the information about the ports may be acquired by any technique, as long as it becomes apparent which switches are connected to the ports of each switch. For example, a unique, private MIB may be used. Also, it is possible to use a mechanism other than SNMP, and mount the mechanism on the device so that the management terminal 1 can acquire the information about the ports from each switch.

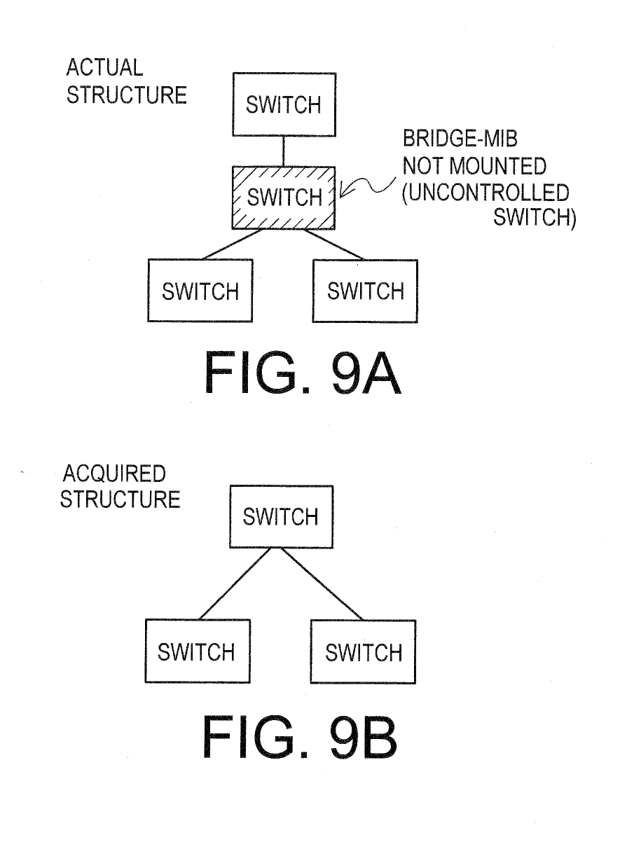

The above description is based on the assumption that the information about the ports can be acquired from each switch. In a case where port information cannot be acquired since some of the switches are not compatible with SNMP or does not have BRIDGE-MID mounted thereon, for example, the switch cannot be detected by the management terminal. By the method according to the above embodiments, when only two switches are connected to such a switch (referred to as the uncontrolled switch), the two switches are determined to be the switches connected directly to the uncontrolled switch. On the other hand, in a case where three or more switches are connected to the uncontrolled switch as shown in FIG. 9A, more than one switch appears to be connected to the same port as shown in FIG. 93. If there is such a situation, an uncontrolled switch (or uncontrolled switches) may be determined to be connected to a port that appears to have more than one switch connected thereto, and the other switches may be determined to be connected to the uncontrolled switch.

In a case where a VLAN is set in the network from which the information about the structure is to be acquired in the above embodiments, the physical connections other than the connections of the VLAN (the management VLAN) to which the management terminal belongs cannot be determined. In other words, where a VLAN uses physical connections other than the management VLAN, the structure of the connections cannot be determined. However, in a case where all VLANs use the same physical connections as those used by the management VLAN through tags, the network structure can be determined with no trouble. Also, physical connections that are not used in actual communications (such as blocking STP or redundant backup paths) cannot be detected.

Although the devices constituting a network are L2 switches in the above description, the present invention has riot been developed to detect only L2 network structures. As long as a subject network can be represented by a tree structure, the information about the structure of the network formed with arbitrary devices can be acquired.

What is claimed is:

1. A network structure information acquiring method for acquiring information about connection relationships in a network formed with a plurality of network devices, the connection relationships being represented by a tree structure having a predetermined network device as a root node,
the method comprising:
a step of acquiring information about ports held by each of the network devices, and network devices connected to each of the ports, from each of the network devices; and
a step of analyzing structures in the network, by determining connection relationships in the network based on a fact that an arbitrary partial tree in the tree structure is smaller than an upstream partial tree containing the arbitrary partial tree.

2. The network structure information acquiring method according to claim 1, wherein
when ports to which the root node is connected are defined as upstream ports, and the other ports are defined as downstream ports,
the step of analyzing structures in the network includes a step of determining the connection relationship, by identifying the network device having the largest number of downstream devices among the network devices connected to a downstream port of a network device having a connection relationship determined, as a network device connected directly to the downstream port of the network device having the connection relationship determined, and the step of determining the connection relationships being repeatedly carried out, with the root node being the network device having a connection relationship first determined.

3. The network structure information acquiring method according to claim 2, wherein
when the network device having the connection relationship determined has a plurality of downstream ports, connection relationships on a downstream side are determined in a parallel manner about at least two of the downstream ports.

4. The network structure information acquiring method according to claim 1, wherein
when ports to which the root node is connected are defined as upstream ports, and the other ports are defined as downstream ports,
the step of analyzing structures in the network includes, after identifying the root node, determining the connection relationships by successively identifying devices connected to the upstream ports, starting from the network device having the largest number of downstream devices among the network devices other than the root node.

5. The network structure information acquiring method according to claim 1, wherein
when ports to which the root node is connected are defined as upstream ports, and the other ports are defined as downstream ports,
the step of analyzing structures in the network includes, determining the network devices having no downstream ports as edge nodes among the plurality of network devices, and determining connection relationships by successively identifying devices connected directly to downstream ports of the network devices other than the edge nodes, starting from the network device having the smallest number of downstream devices.

6. The network structure information acquiring method according to claim 1, wherein
when ports to which the root node is connected are defined as upstream ports, and the other ports are defined as downstream ports,
the step of analyzing structures in the network includes, after determining connection relationships by identifying network devices having no downstream ports as edge nodes among the plurality of network devices, a step of detecting a network device that has downstream devices connected thereto and all having connection relationships determined, and determining a connection relationship of the detected network device, the network device being detected from network devices other than network devices having connection relationships determined, and the step of detecting and determining being repeatedly carried out.

7. The network structure information acquiring method according to claim 1, wherein
the network devices are L2 switches, and
information about ports of the L2 switches and the L2 switches connected to each of the ports is acquired by SNMP.

8. A network structure information acquiring method for acquiring information about connection relationships in a network formed with a plurality of L2 switches functioning as SNMP agents, the connection relationships being represented by a tree structure having a predetermined L2 switch as a root node,
the method comprising:
a step of acquiring port information, by performing communications with the L2 switches by SNMP, acquiring MAC addresses of ports of the L2 switches and all the L2 switches connected directly to the respective ports or indirectly to the respective ports via the other L2 switches, and storing the MAC addresses into a port information table;
a step of determining the L2 switch having the largest number of L2 switches connected to downstream ports as the root node having a connection relationship first determined among the L2 switches, when ports to which a SNMP manager is connected are defined as upstream ports, and the other ports are defined as downstream ports among the respective L2 switches; and
a step of analyzing structures in the network, by determining connection relationships of the L2 switch having the largest number of downstream devices as the L2 switch connected directly to a downstream port of the L2 switch having a connection relationship determined, among the L2 switches connected to the downstream ports of the L2 switch having the connection relationship determined.

9. A network structure information acquiring method for acquiring information about connection relationships in a network formed with a plurality of L2 switches functioning as SNMP agents, the connection relationships being represented by a tree structure having a predetermined L2 switch as a root node,
the method comprising:
a step of acquiring port information, by performing communications with the L2 switches by SNMP, acquiring MAC addresses of ports of the L2 switches and all the L2 switches connected directly to the respective ports or indirectly to the respective ports via the other L2 switches, and storing the MAC addresses into a port information table;
a step of determining the L2 switches having no downstream ports as edge nodes among the L2 switches, when ports to which a SNMP manager is connected are defined as upstream ports, and the other ports are defined as downstream ports among the respective L2 switches; and
a step of analyzing structures in the network, by determining connection relationships by successively identifying L2 switches connected directly to downstream ports of the L2 switches other than the edge nodes with reference to the port information table, starting from a network device having the smallest number of downstream devices.

10. A network structure information acquiring device that acquires information about connection relationships in a network formed with a plurality of network devices, the connection relationships being represented by a tree structure having a predetermined network device as a root node,
the network structure information acquiring device comprising:
a port information acquiring unit that acquires information about ports held by each of the network devices, and network devices connected to each of the ports, from each of the network devices; and
a network structure analyzing unit that determines connection relationships in the network, based on a fact that an arbitrary partial tree in the tree structure is smaller than an upstream partial tree containing the arbitrary partial tree.

11. The network structure information acquiring device according to claim 10, wherein
when ports to which the root node is connected are defined as upstream ports, and the other ports are defined as downstream ports,
the network structure analyzing unit determines the root node as the network device having a connection relationship first determined, and determines a connection relationship by identifying the network device having the largest number of downstream devices among the network devices connected to a downstream port of a network device having a connection relationship determined, as a network device connected directly to the downstream port of the network device having the connection relationship determined.

12. The network structure information acquiring device according to claim 11, wherein
when the network device having the connection relationship determined has a plurality of downstream ports, the network structure analyzing unit determines connection relationships on a downstream side in a parallel manner about at least two of the downstream ports.

13. The network structure information acquiring device according to claim 10, wherein
when ports to which the root node is connected are defined as upstream ports, and the other ports are defined as downstream ports,
the network structure analyzing unit first identifies the root node, and determines connection relationships by successively identifying devices connected to the upstream ports, starting from the network device having the largest number of downstream devices among the network devices other than the root node.

14. The network structure information acquiring device according to claim 10, wherein
when ports to which the root node is connected are defined as upstream ports, and the other ports are defined as downstream ports,
the network structure analyzing unit determines network devices having no downstream ports as edge nodes among the plurality of network devices, and determines connection relationships by successively identifying devices connected directly to downstream ports of the network devices other than the edge nodes, starting from the network device having the smallest number of downstream devices.

15. The network structure information acquiring device according to claim 10, wherein
when ports to which the root node is connected are defined as upstream ports, and the other ports are defined as downstream ports,
the network structure analyzing unit determines connection relationships by identifying network devices having no downstream ports as edge nodes among the plurality of network devices, detects a network device that has downstream devices connected thereto and all having connection relationships determined, and determines a connection relationship of the detected network device, the network device being detected from network devices other than network devices having connection relationships determined.

16. The network structure information acquiring device according to claim 10, wherein
the network devices are L2 switches, and
information about ports of the L2 switches and the L2 switches connected to each of the ports is acquired by SNMP.

17. A network structure information acquiring device that acquires information about connection relationships in a network formed with a plurality of L2 switches functioning as SNMP agents, the connection relationships being represented by a tree structure having a predetermined L2 switch as a root node,
the network structure information acquiring device comprising:
a port information acquiring unit that performs communications with the L2 switches by SNMP, acquires MAC addresses of ports of the L2 switches and all the L2 switches connected directly to the respective ports or indirectly to the respective ports via the other L2 switches, and stores the MAC addresses into a port information table; and
a network structure analyzing unit that determines the L2 switch having the largest number of L2 switches connected to downstream ports to be the root node having a connection relationship first determined among the L2 switches, when ports to which the network structure information acquiring device is connected are defined as upstream ports, and the other ports are defined as downstream ports among the respective L2 switches, and determines connection relationships by determining the L2 switch having the largest number of downstream devices to be the L2 switch connected directly to a downstream port of the L2 switch having a connection relationship determined, among the L2 switches connected to the downstream ports of the L2 switch having the connection relationship determined.

18. A network structure information acquiring device that acquires information about connection relationships in a network formed with a plurality of L2 switches functioning as SNMP agents, the connection relationships being represented by a tree structure having a predetermined L2 switch as a root node,
the network structure information acquiring device comprising:
a port information acquiring unit that performs communications with the L2 switches by SNMP, acquires MAC addresses of ports of the L2 switches and all the L2 switches connected directly to the respective ports or indirectly to the respective ports via the other L2 switches, and stores the MAC addresses into a port information table; and
a network structure analyzing unit that determines the L2 switches not having downstream ports to be edge nodes among the L2 switches, when ports to which the network structure information acquiring device is connected are defined as upstream ports, and the other ports are defined as downstream ports among the respective L2 switches, and determines connection relationships by successively identifying L2 switches connected directly to downstream ports of the L2 switches other than the edge nodes with reference to the port information table, starting from a network device having the smallest number of downstream devices.

19. A network structure information acquiring program implemented in a management terminal for acquiring information about connection relationships in a network formed with a plurality of network devices, the connection relationships being represented by a tree structure having a predetermined network device as a root node,
the network structure information acquiring program causing the management terminal to:
acquire information about ports held by each of the network devices, and network devices connected to each of the ports, from each of the network devices; and
determine connection relationships in the network, based on a fact that an arbitrary partial tree in the tree structure is smaller than an upstream partial tree containing the arbitrary partial tree.

20. A computer readable recording medium storing the network structure information acquiring program according to claim 19.
